(19) United States
(12) Patent Application Publication
(10) Pub. No.: US 2025/0346167 A1
(43) Pub. Date: Nov. 13, 2025

(54) ROOF HANDLE FOR VEHICLES

(71) Applicant: H+E Molding Solutions GmbH, Ittlingen (DE)

(72) Inventor: Milto BENJAMIN, Gütersloh (DE)

(73) Assignee: H+E Molding Solutions GmbH, Ittlingen (DE)

(21) Appl. No.: 18/866,604

(22) PCT Filed: Jun. 5, 2023
(86) PCT No.: PCT/EP2023/064993

§ 371 Date: Nov. 18, 2024

(30) Foreign Application Priority Data
Jun. 8, 2022 (DE) 10 2022 114 443.7

(51) Int. Cl. B60N 3/02

(52) U.S. Cl. CPC B60N 3/023

(57) ABSTRACT

A roof handle for vehicles includes at least one bearing block on which a handle body is held and which can be fixed to an opening on a vehicle roof, the opening being surrounded by an edge, wherein the at least one bearing block includes an insertion part which can be inserted through the opening with at least one clamping body that can be positioned to reach behind the edge of the opening, wherein a latch that can be inserted into the insertion part is provided, by means of which the at least one clamping body can be locked in the position reaching behind the edge. This allows the roof handle to be mounted on the vehicle roof effectively.

The present invention relates to a roof handle for vehicles with at least one bearing block on which a handle body is held and which can be fixed to an opening on a vehicle roof, the opening being surrounded by an edge, wherein the at least one bearing block comprises an insertion part which can be inserted through the opening with at least one clamping body that can be positioned to reach behind the edge of the opening.

DE 10 2019 116 491 A1 discloses a roof handle for vehicles in which a handle body is held on two bearing elements, each of which can be fixed to an opening on the vehicle roof via an insertion part. For latching, protruding clips with spring webs are provided on each bearing element, which latch when inserted through the opening on the vehicle roof and reach behind the edge of the opening. The bearing element is secured against being pulled out by inserting a securing element into the clip. To ensure that the retaining forces of the spring webs on the bearing element are sufficient, each spring web consists of a bendable metal sheet and must be pushed through the opening on the vehicle roof with a certain amount of force, which makes mounting the roof handle more difficult, especially if the same person has to mount a large number of roof handles in one day. It is also difficult to remove the roof handle once it has to be replaced, as the spring webs have to be bent over using a special tool.

In WO 2008/055838 A1, a holding device for a handle is disclosed, in which a separate spreader element is fixed to a support part, which can be inserted into a hole and can be locked via a locking member. Spring tongues are formed on the spreader element, which engage around an edge of an opening to fix the support part.

U.S. Pat. No. 8,146,208 B2 discloses a handle that can be fixed to a vehicle body using metal clips. The clamps comprise spring webs in order to reach behind a mounting opening.

It is therefore the problem to be solved by the present invention to create a roof handle for vehicles which is easy to install and can absorb high holding forces.

This problem is solved by a roof handle with the features of claim 1.

In the roof handle according to the invention, at least one clamping body is provided on an insertion part insertable into an opening, which clamping body can reach behind an edge of the opening after mounting, wherein a latch that can be inserted into the insertion part is provided, by means of which the at least one clamping body can be locked in the position reaching behind the edge. As a result, the insertion part can be inserted with little force, because the clamping body can be brought into a position reaching behind the edge at the opening by moving the latch, so that the at least one clamping body can be passed through the opening with little or no force resistance. This allows the mounting forces to be decoupled from the subsequent holding forces. In addition, the roof handle can be easily dismantled by first pulling the latch at least partially out of the insertion part in a two-stage method before the bearing block with the insertion part is then pulled out of the opening.

For a compact design, the latch can be inserted into a channel on the insertion part. The latch can be slidably held on the bearing block between a pre-mounted position with at least one movable clamping body and a locked position with at least one locked clamping body.

The insertion part with the channel is preferably formed integrally with the bearing block, which comprises a supporting section that is wider than the insertion part and can be supported on the vehicle roof. This means that the roof holder handle can be manufactured with just a few components. The clamping body is preferably made from a different material than the insertion part, in particular from a material with higher strength.

A recess for the reception of the at least one clamping body is preferably formed in at least one wall of the insertion part. This allows forces to be transmitted from the wall to the clamping body and the edge at the opening in the locked position. The wall of the insertion part above the clamping body can be formed with a low overall construction height, so that the installation volume is reduced compared to the previously known fastening means with the latching webs. The recess can be formed as a cage, which holds the clamping body loosely on the insertion part and limits movement of the clamping body out of the insertion part. The clamping body can be moved with play within the cage before it is clamped by the latch.

The clamping body can be held unlosable in the recess on the wall if the insertion part at least pre-fixes the clamping body.

In a further embodiment, the latch comprises at least one pressing surface which is inclined to the direction of insertion and by means of which the at least one clamping body can be moved outwards from the insertion part. The pressing surface, which is inclined to the direction of insertion, for example with an inclination to the direction of insertion of between 1° and 10°, can be used to brace the clamping body outwards in order to ensure that the clamping body and the bearing block are fixed to the edge of the opening without play.

For easy mounting, the latch can preferably be latched in the locked position on the bearing block or the insertion part, whereby respectively bendable latching webs or other latching means can be formed on the latch and/or the insertion part. Instead of bendable latching webs, a clamp can also be used to fasten the latch, whereby the latching can preferably be perceived acoustically and haptically during mounting.

The latch preferably includes at least one bendable web, to which the at least one clamping body can be fixed in a pre-mounted position, in which the latch is at least partially inserted into the insertion part and the at least one clamping body is already located in the recess on the insertion part. From this pre-mounted position, the latch can then be moved relative to the insertion part and the clamping body held therein in order to remove the at least one clamping body from a receptable on the bendable web and to arrange the bendable web in the locked position at a distance from the at least one clamping body. This enables movement of the clamping body perpendicular to the insertion direction in the pre-mounted position via the bendable web, while this movement is blocked by the latch after the flow into the locked position, because adjacent to the clamping body no bendable web, but the latch, in particular made of a solid material, contacts the at least one clamping body. The at least one bendable web of the latch can optionally comprise one or more slots at the end, into which a stabilising web can be inserted at the channel of the insertion part when the latch is pushed in.

The at least one clamping body is preferably formed essentially cylindrically. The at least one clamping body can be a cylindrical pipe, sleeve or made from a solid material, preferably metal. Optionally, the at least one clamping body can be made from a wound wire, which increases the elasticity. The cross-section of the wire can be circular, but also square or polygonal. In a preferred embodiment, the at least one clamping body comprises at least one cutting edge that can be at least partially driven into the edge of the opening, so that in the locked position the bearing block is also secured against flow in the axial direction of the clamping body. The outer diameter of the cylindrical clamping body is preferably less than 8 mm, in particular between 4 mm and 6 mm. Furthermore, the clamping body can be formed as a sleeve and slotted, in particular in the axial direction, in order to increase elasticity. Furthermore, the at least one clamping body can also comprise a different geometry, for example be formed as a sphere or barrel.

Preferably, two clamping bodies are provided on opposite sides of the insertion part, each of which is supported at the edge of the opening. This centres the insertion part via the clamping bodies and also increases the holding forces. Optionally, more than two clamping bodies can also be provided on the insertion part, in particular three or four clamping bodies. Each clamping body preferably consists of a different material than the insertion part and/or the latch.

The roof handle preferably comprises two bearing blocks on which a pivotable handle body is held, whereby the bearing blocks can preferably be inserted into recesses on the handle body when the handle body is folded up so that the handle body can optimally adapt to the contour of the vehicle roof. The roof handle does not have to be fixed directly to a metal sheet of the vehicle roof, but can also be fixed indirectly to the vehicle roof via the interposition of one or more components.

In a further embodiment, the handle body includes a pressing piece by means of which the latch can be pushed into the insertion part. This allows the optimised lever ratios on the handle body to be used to insert the latch with little effort. Preferably, the handle body comprises two pressing pieces and a swivelling movement of the handle body pushes a latch into one of the two bearing blocks simultaneously via each pressing piece. This reduces the number of mounting steps, as both latches can be moved into the locked position with one movement.

The invention is explained in more detail below with reference to the accompanying drawings. It is shown in:

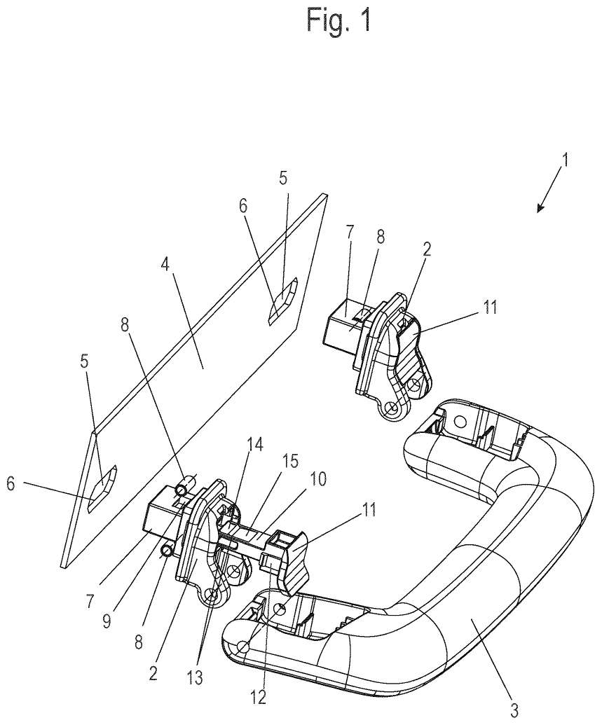

FIG. 1 an exploded view of a roof handle according to the invention;

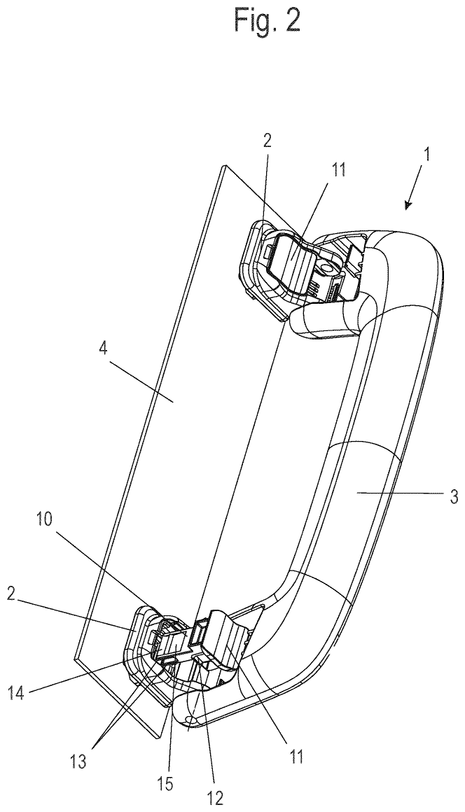

FIG. 2 a perspective view of the roof handle of FIG. 1 during mounting;

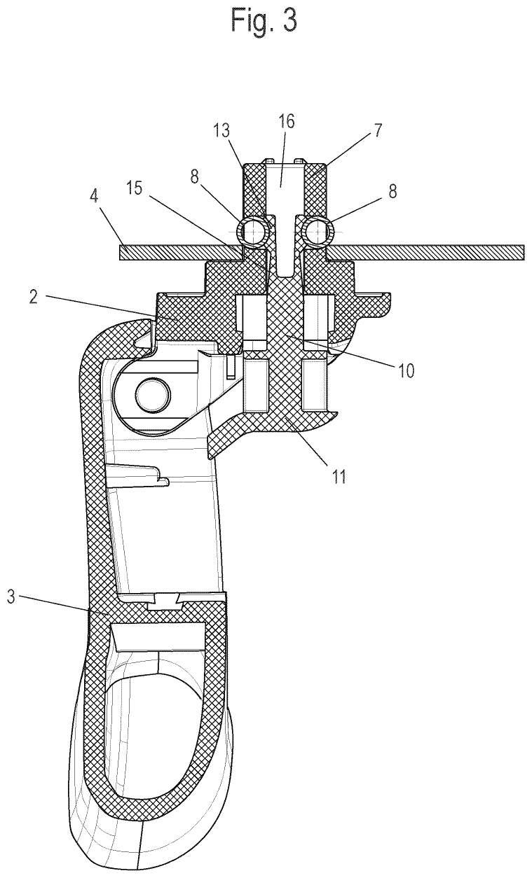

FIG. 3 a sectional view of the roof handle of FIG. 1 in the pre-mounted position;

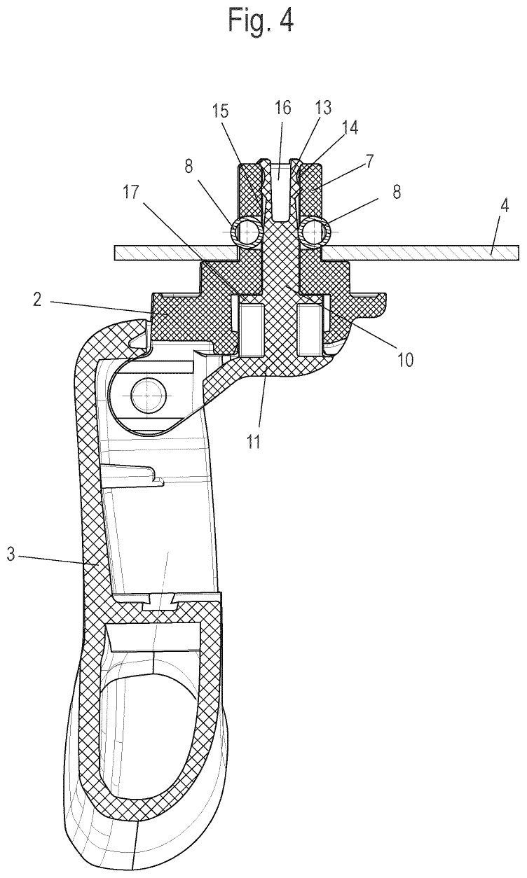

FIG. 4 a sectional view of the roof handle of FIG. 1 in the locked position;

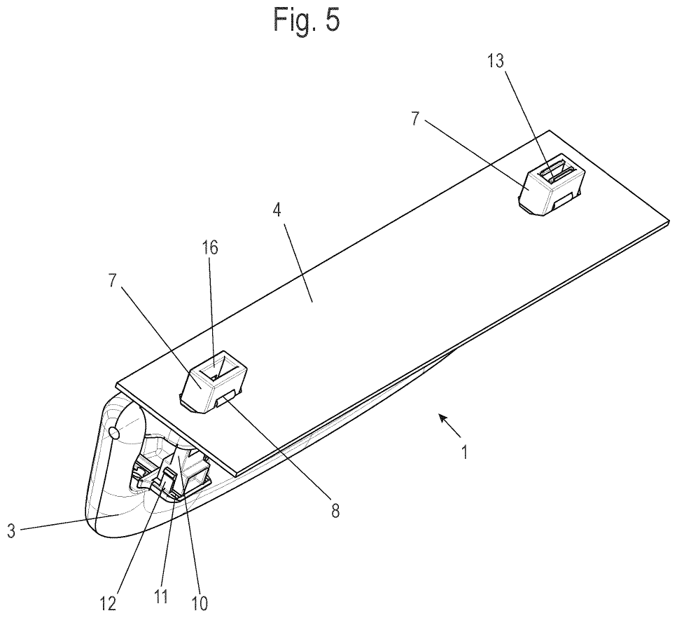

FIG. 5 a perspective view of the roof handle in the mounted position, looking onto the vehicle roof;

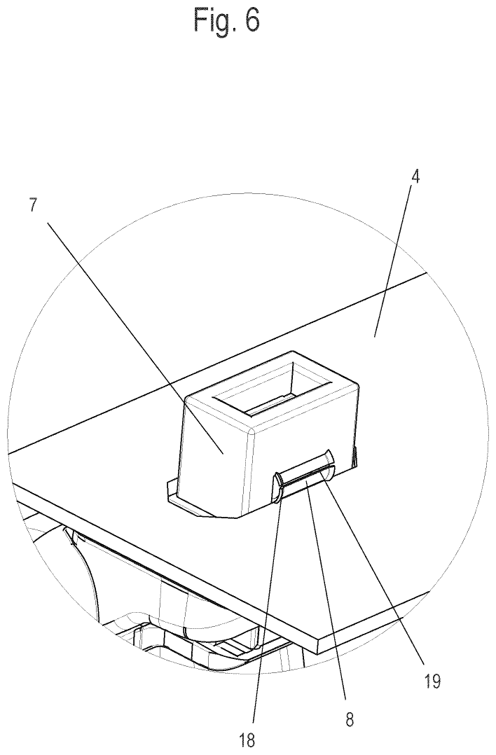

FIG. 6 a detailed view of a mounted bearing block according to a modified embodiment example;

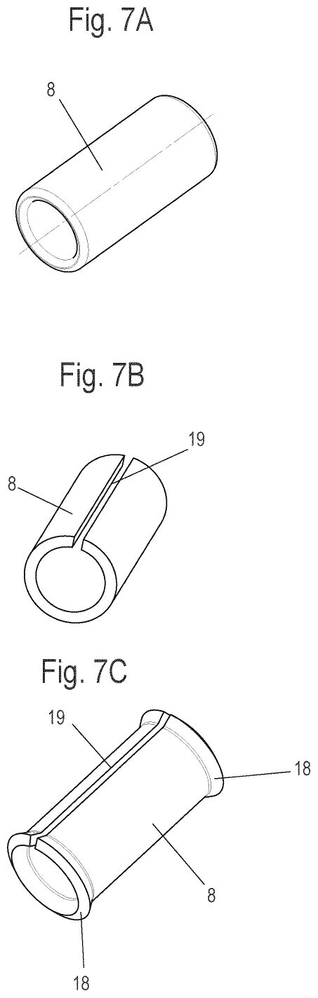

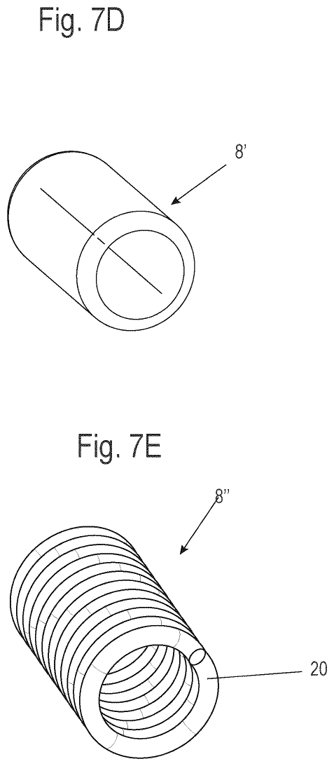

FIGS. 7A to 7E several views of different clamping bodies, and

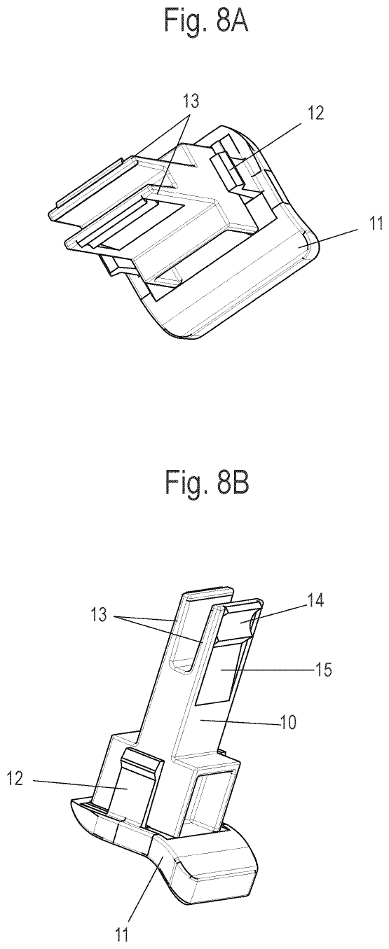

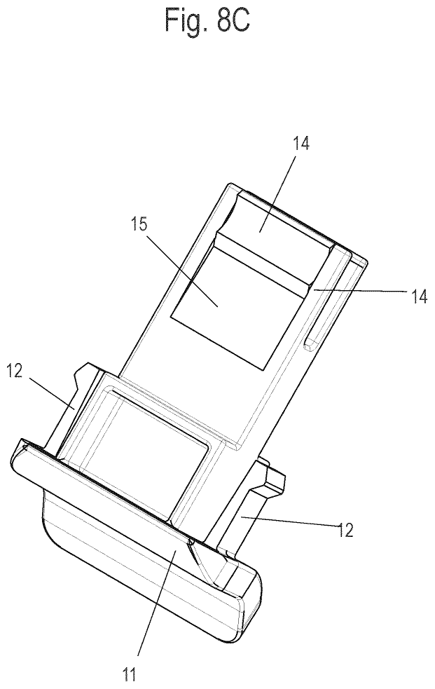

FIGS. 8A to 8C several views of the latch of the roof handle;

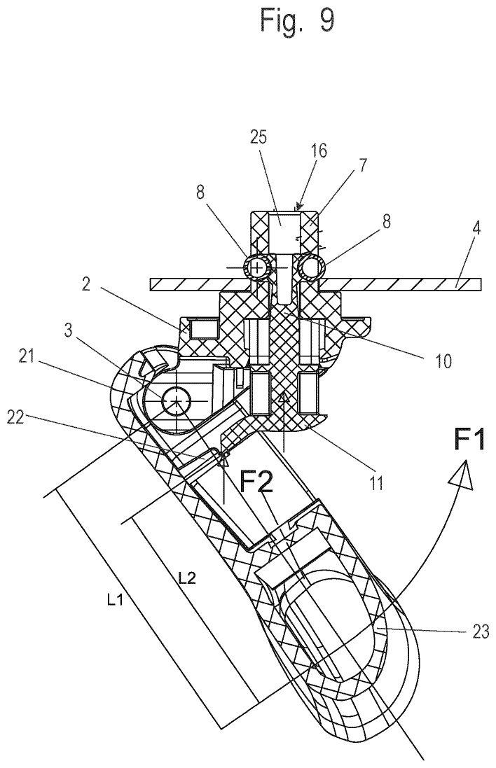

FIG. 9 a sectional view of a modified roof handle during mounting;

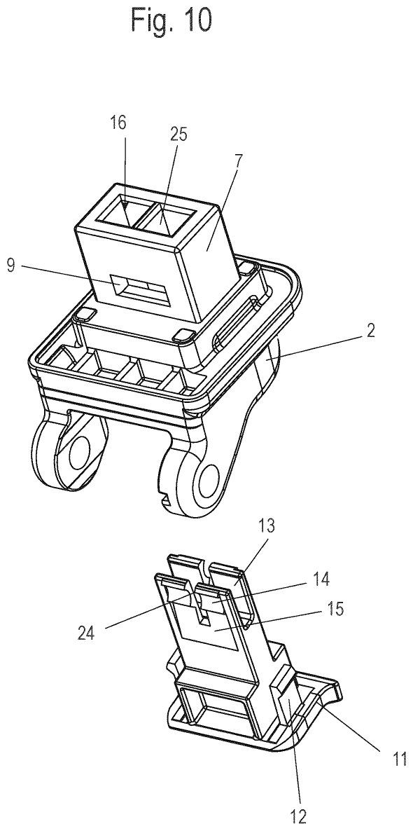

FIG. 10 an exploded view of a bearing block with a latch of the roof handle of FIG. 9, and

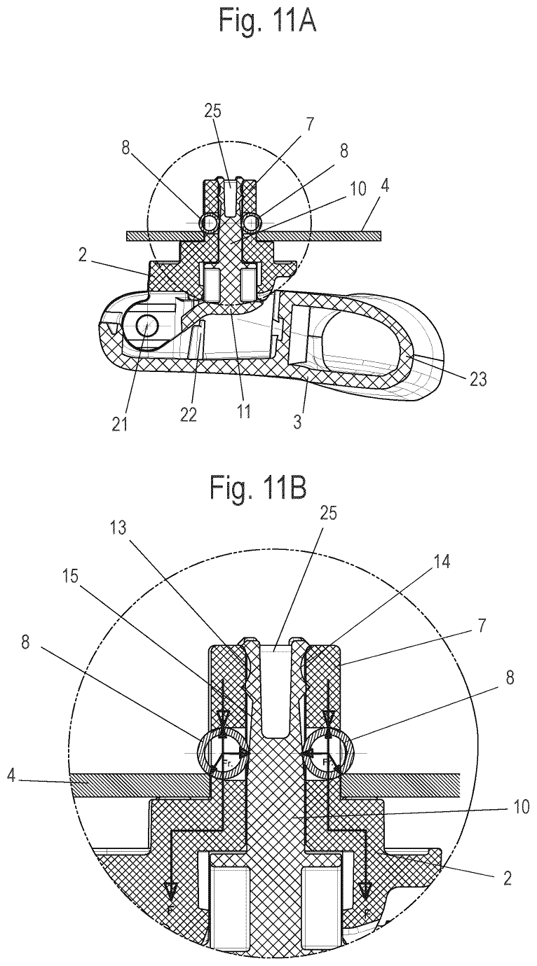

FIGS. 11A and 11B two sectional views of the roof handle of FIG. 9 in the mounted position.

A roof handle 1 includes two bearing blocks 2, on which a bow-shaped handle body 3 is pivotably mounted or optionally rigidly fixed. Each bearing block 2 is fixed to a vehicle roof 4 at an opening 5, which is surrounded by an edge 6. The schematically illustrated vehicle roof 4 can be made of a metal sheet and be provided directly with two openings 5, or further components can be fixed to the vehicle roof 4, which comprise an opening to which the roof handle 1 is attached.

In FIG. 1, the rear bearing block 2 is shown in the locked position, while the front bearing block 2 is shown in a pre-mounted position. Each bearing block 2 includes an insertion part 7, which can be inserted into the opening 5 on the vehicle roof 4. Recesses 9 are formed on opposite walls of the insertion part 7, each of which serves for the reception of a clamping body 8.

A latch 10 can be inserted on each bearing block 2, which can be pushed into a channel on the bearing block 2 and the insertion part 7. The latch 10 includes a handle section 11, which can be mounted on the bearing block 2 on the side facing the handle body 3 and can be latched via at least one latching web 12. For this purpose, the bendable latching web 12 is provided with a projection which can be latched into a receptable on the bearing block 2.

The latch 10 includes two bendable webs 13 on the side facing away from the handle section 11, wherein a recessed, in particular curved, receptable 14 is formed on each web 13 on the side facing the clamping body 8, which lies against an outer contour of the clamping body 8 in the pre-mounted position. Adjacent to the receptable 14, a pressing surface 15 is formed, which is orientated at an angle to the insertion direction and by means of which the clamping body 8 can be moved towards an outer side of the insertion part 7 in order to clamp it.

In FIG. 2, the roof handle 1 is shown in a mounted position in which a widened portion of the bearing block rests on the underside of the vehicle roof 4 and the respective insertion part 7 is inserted through the opening 5 in the vehicle roof 4. In one bearing block 2, the latch 10 is already inserted into the locking position, and the handle section 11 is essentially flush with a surface of the bearing block 2. The other latch 10 is still outside the bearing block 2.

FIG. 3 shows a section through the roof handle 1 in the area of a bearing block 2, with the latch 10 in a pre-mounted position. Clamping bodies 8 are inserted into the receptacles 14 on the two bendable webs 13 of the latch 10, whereby in this pre-mounted position the bearing block 2 together with the latch 10 can be pushed through the opening 5 with little effort, as the clamping bodies 8 can press the bendable webs 13 inwards at the edge 6, so that the clamping bodies 8 latch onto the edge 6 of the opening 5 after being pushed through. In this pre-mounted position, the roof handle 1 can also be removed from the vehicle roof 4 again with little effort by pulling the insertion part 7 out of the opening 5.

To lock the bearing block 2 to the vehicle roof 4, the latch 10 is pushed into the channel 16 on the insertion part 7 so that the two clamping bodies 8 are each removed from the receptable 14 on the bendable webs 13. The clamping bodies 8 now come against the pressing surface 15, which is formed at an angle to the insertion direction and presses the clamping bodies outwards until the position shown in FIG. 4 is reached. In the locking position, the bendable webs 13 are at a distance from the clamping bodies, and these are pressed outwards by the pressing surface 15, whereby the recess 9 in the wall of the insertion part 7 comprises a smaller size than the outer diameter of the clamping body 8, so that the latter cannot be completely pressed out of the insertion part 7 by the pressing surface 15.

If the handle body 3 is pulled in this locking position, force is applied to the vehicle roof 4 via the insertion part 7 and the two clamping bodies 8, which rest on the edge 6 of the opening 5. Movement of the clamping bodies 8 towards each other is prevented by the latch 10, which is formed to be dimensionally stable between the clamping bodies 8 and is preferably made of a solid material in this area. The insertion depth of the latch 10 can be limited by a stop 17, which protrudes and interacts with a contact area on the bearing block 2. Optionally, stops can also be provided at other positions to limit the insertion depth. In addition, the latch 10 is latched in the locking position via the at least one latching web 12.

In FIG. 5, the roof handle 1 is shown in a mounted position in which the two insertion parts 7 are guided through the vehicle roof 4. The height of the insertion part 7 is low compared to the previously known solutions, for example less than 20 mm, in particular less than 15 mm, so that only a small volume above the vehicle roof 4 is required for mounting the roof handle 1. The clamping bodies 8 rest on opposite sides of the insertion part 7 on the edge 6 of the opening 5 and thus centre the insertion part 7.

FIG. 6 shows a detailed view of a modified bearing block 2, in which the essentially cylindrical clamping body 8 comprises a radially protruding cutting edge 18 on opposite sides. This protruding cutting edge 18, produced for example by bending an end section of a tubular material, can dig into the material of the edge 6 at the opening 5 when the insertion part 7 is loaded, so that the bearing block 2 is prevented from flowing in the axial direction of the clamping body 8 after the insertion part 7 has been fixed. The clamping body 8 also comprises an axial slot 19, which simplifies the manufacture of the clamping body 8.

FIGS. 7A to 7E show various clamping bodies that can be mounted on an insertion part 7. The clamping bodies preferably consist of metal, but can also be made of other materials. FIG. 7A shows a cylindrical clamping body 8, which is formed as a sleeve or pipe, for example made of metal. This clamping body 8 can optionally be provided with an axial slot 19, as shown in FIG. 7B. In addition to the axial slot 19, a radially protruding cutting edge 18 can respectively be formed at one end section or at opposite end sections in order to secure the clamping body 8 against axial flow.

FIG. 7D shows a modified clamping body 8′ that is made from a solid material instead of a sleeve. Instead of the smooth cylindrical outer wall, the outer wall can also be profiled or embossed to make the clamping body 8′ resistant to displacement.

FIG. 7E shows a clamping body 8″ made from a coiled wire 20. The wire 20 is formed in a helix and can be inserted into the recess 9 on the insertion part 7. Instead of a circular cross-section of the wire 20, wires with a different cross-sectional geometry can also be used, for example square or polygonal with an outer corner, so that the shaping of the wire ensures increased protection against a flow of the clamping body 8″ in the axial direction.

FIGS. 8A to 8C show the latch 10 in detail, which comprises a pin-shaped element with an essentially rectangular cross-section, on which webs 13 that can be bent at the ends are formed. Each web 13 comprises the rounded receptable 14 and the pressing surface 15. The pin of the latch 10 widens towards the handle section 11 and can thus be inserted into the bearing block 2 and latched there via the latching web 12.

The roof holder handle shown in FIG. 9 differs from the previous embodiment example by a stabilising web 25, which connects two opposite walls on the channel 16 of the insertion part 7. The stabilising web 25 reinforces the insertion part 7 in an area above the vehicle roof 4. It is also shown that the latch 10 does not have to be fitted by hand to facilitate mounting, but that the handle body 3 can be used instead. For this purpose, a pressing piece 22 in the form of a protruding web is formed on the handle body 3, which presses against the handle section 11 of the latch 10 when the handle body 3 is swivelled about an axis 21, so that the latch 10 is pushed into the channel 16. The pressing piece 22 can slide along the handle section 11. This enables smooth mounting, because a handlebar 23 on the handle body 3 is arranged at a greater distance L1 from the axis 21 than from the pressing piece 22, which is arranged at a distance L2 from the handlebar. The effective lever length leads to an optimised transmission ratio when the latch 10 is pushed in. In addition, both latches 10 can be pushed into the locking position simultaneously by pivoting the handle body 3 from the pre-mounted position.

In FIG. 10, the bearing block 2 is shown with a latch 10 of the roof handle of FIG. 9. It can be seen that the stabilising web 25 divides the channel 16 into two separate chambers. In order to be able to insert the latch 10 with the bendable webs 13 into the channel 16, the webs 13 are provided with a slot 24 at the end, into which the stabilising web 25 can be inserted during mounting.

FIGS. 11A and 11B show the locked position in which the latch 10 is fully inserted into the channel 16 by rotating the handle body 3 and the clamping bodies 8 are pressed outwards by the pressing surface 15. If a weight force is introduced downwards into the handle body 3, this leads to a force in the insertion part 7 on the two clamping bodies 8, which are each supported on one side on the latch and additionally on the edge 6 around the opening 6. Due to the symmetrical design, the forces introduced can be optimally transferred to the vehicle roof 4.

In the embodiment examples shown, each bearing block 2 is fixed individually to an opening in the vehicle roof 4. It is of course possible to connect the two bearing blocks 2 together and mount them as a unit. The bearing blocks 2 can also be formed integrally with each other.

### LIST OF REFERENCE SIGNS

1 Roof handle
2 Bearing block
3 Handle body
4 Vehicle roof
5 Opening
6 Edge
7 Insertion part
8, 8′, 8″ Clamping body
9 Recess
10 Latch
11 Handle section
12 Latching web
13 Web
14 Receptable
15 Pressing surface
16 Channel
17 Stop
18 Cutting edge
19 Slot
20 Wire
21 Axis
22 Pressing piece
23 Handlebar
24 Slot
25 Stabilising web

1: A roof handle (1) for vehicles, comprising at least one bearing block (2) on which a handle body (3) is held and which is fixable to an opening (5) on a vehicle roof (4), the opening being surrounded by an edge (6), wherein the at least one bearing block (2) comprises an insertion part (7) which is configured to be inserted through the opening (5) with at least one clamping body (8, 8′, 8″) that is configured to be positioned to reach behind the edge (6) of the opening (5), and further comprising a latch (10) that is configured to be inserted into the insertion part (7), by means of which the at least one clamping body (8, 8′, 8″) can be locked in the position reaching behind the edge (6).

2: The roof handle according to claim 1, wherein the latch (10) is configured to be pushed into a channel (16) on the insertion part (7).

3: The roof handle according to claim 1, wherein a recess (9) for the reception of the at least one clamping body (8, 8′, 8″) is formed in a wall on the insertion part (7).

4: The roof handle according to claim 3, wherein the recess (9) is formed as a cage which holds the clamping body (8, 8′, 8″) loosely on the insertion part (7).

5: The roof handle according to claim 1, wherein the latch (10) comprises at least one pressing surface (15) which is aligned at an angle to the insertion direction and by means of which the at least one clamping body (8, 8′, 8″) is movable outwards from the insertion part (7).

6: The roof handle according to claim 1, wherein the latch (10) is configured to be latched in a locked position on the bearing block (2).

7: The roof handle according to claim 1, wherein the latch (10) comprises at least one bendable web (13) on which the at least one clamping body (8, 8′, 8″) is fixable in a pre-mounted position and the latch (10) is displaceable relative to the clamping body (8, 8′, 8″) held on the insertion part (7) in order to position the bendable web (13) in the locked position at a distance from the at least one clamping body (8, 8′, 8″).

8: The roof handle according to claim 1, wherein the at least one clamping body (8, 8′, 8″) has a substantially cylindrical shape.

9: The roof handle according to claim 1, wherein the at least one clamping body (8, 8′, 8″) comprises at least one cutting edge (18) which is configured to be driven at least partially into the edge (6) in the opening (5).

10: The roof handle according to claim 1, wherein the at least one clamping body (8″) is made of a wound wire (20).

11: The roof handle according to claim 1, wherein two said clamping bodies (8, 8′, 8″) are provided on opposite sides of the insertion part (7), each said clamping body being supported on the edge (6) of the opening (5).

12: The roof handle according to claim 1, wherein the roof handle (1) includes two said bearing blocks (2) on which the handle body (3) is pivotably held.

13: The roof handle according to claim 12, wherein the handle body (3) includes at least one pressing piece (22) that is configured for pushing the latch (10) into the insertion part (7).

14: The roof handle according to claim 13, wherein the handle body (3) includes two pressing pieces (22) and, by a pivoting movement of the handle body (3) by each pressing piece (22), a latch (10) can be pushed in simultaneously on one of the two bearing blocks (2).

15: A vehicle with a vehicle roof (4), to which at least one roof handle (1) according to claim 1 is fixed.
